(19) United States
(12) Patent Application Publication
(10) Pub. No.: US 2016/0105261 A1
(43) Pub. Date: Apr. 14, 2016

(54) System and Method for Space-Time Block Coded Communications

(71) Applicant: Huawei Technologies Co., Ltd., Shenzhen (CN)

(72) Inventors: Jung Hoon Suh, Kanata (CA); Osama Aboul-Magd, Kanata (CA)

(21) Appl. No.: 14/877,748

(22) Filed: Oct. 7, 2015

Related U.S. Application Data
(60) Provisional application No. 62/062,004, filed on Oct. 9, 2014.

(51) Int. Cl. H04L 1/06; H04W 84/12

(52) U.S. Cl. CPC H04L 1/0618; H04W 84/12

(57) ABSTRACT

A method for wireless communications includes encoding a training sequence thereby producing an encoded training sequence, placing the encoded training sequence in a first part of a multi-part preamble, and transmitting the multi-part preamble using a first transmit antenna and a second transmit antenna.

### CROSS-REFERENCE TO RELATED APPLICATIONS

This application claims the benefit of U.S. Provisional Application No. 62/062,004, filed on Oct. 9, 2014, entitled “Space-Time Block Code-Based Signal Field Systems and Methods,” which application is hereby incorporated herein by reference. This application is related to U.S. Provisional Application No. 62/069,632, filed on Oct. 28, 2014, entitled “System and Method for Utilizing Long Training Field and Space-Time Block Code-Based Signal Field”, and U.S. application Ser. No. 14/875,111, filed on Oct. 5, 2015, entitled “System and Method for Wireless Communication Using Space-Time Block Code Encoding,” which applications are hereby incorporated herein by reference.

### TECHNICAL FIELD

The present disclosure relates generally to digital communications, and more particularly to a system and method for space-time block coded communications.

### BACKGROUND

IEEE 802.11ax is the successor to IEEE 802.11ac and is intended to increase the efficiency of wireless local area network (WLAN) networks so as to provide about four times the throughput of 802.11ac. IEEE 802.11ax is intended to provide eight multiple-input multiple-output (MIMO) spatial streams. An outdoor scenario has been added to the applications of 802.11ax, and a portion of the preamble of a packet that is necessary for backward compatibility (commonly referred to as the legacy preamble portion) is vulnerable to the hostile outdoor channel.

### SUMMARY OF THE DISCLOSURE

Example embodiments provide a system and method for space-time block coded communications.

In accordance with an example embodiment, a method for wireless communications is provided. The method includes encoding, by a transmission point, a training sequence thereby producing an encoded training sequence, placing, by the transmission point, the encoded training sequence in a first part of a multi-part preamble, and transmitting, by the transmission point, the multi-part preamble on at least two streams using a first transmit antenna and a second transmit antenna.

In accordance with another example embodiment, a method for wireless communications is provided. The method includes space-time block code (STBC) encoding, by a transmission point, a signal thereby producing two space-time streams, placing, by the transmission point, the two space-time streams in a first part of a multi-part preamble, and transmitting, by the transmission point, the multi-part preamble.

In accordance with another example embodiment, a transmission point is provided. The transmission point includes a processor, and a computer readable storage medium storing programming for execution by the processor. The programming including instructions configuring the transmission point to encode a training sequence thereby producing an encoded training sequence, to place the encoded training sequence in a first part of a multi-part preamble, and to transmit the multi-part preamble on at least two streams using a first transmit antenna and a second transmit antenna.

In accordance with another example embodiment, a transmission point is provided. The transmission point includes a processor, and a computer readable storage medium storing programming for execution by the processor. The programming including instructions configuring the transmission point to space-time block code (STBC) encode a signal thereby producing two space-time streams, to place the two space-time streams in a first part of a multi-part preamble, and to transmit the multi-part preamble.

Practice of the foregoing embodiments enables diversity gain by providing duplicate streams while maintaining compatibility with legacy devices.

Moreover, auto detection is provided in some embodiments.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example wireless communications system according to example embodiments described herein;

FIG. 2A illustrates a portion of a first communications system according to example embodiments described herein;

FIG. 2B illustrates a portion of a second communications system according to example embodiments described herein;

FIG. 3A illustrates an example packet according to example embodiments described herein;

FIG. 3B illustrates an example packet of an 802.11 compliant communications system according to example embodiments described herein;

FIG. 3C illustrates an example mixed mode packet according to example embodiments described herein;

FIG. 4A illustrates a high-level view of a multi-part preamble wherein each part includes two STBC data streams according to example embodiments described herein;

FIG. 4B illustrates a detailed view of a portion of a first example multi-part preamble according to example embodiments described herein;

FIG. 4C illustrates a detailed view of a portion of a second example multi-part preamble according to example embodiments described herein;

FIG. 4D illustrates a detailed view of a portion of a third example multi-part preamble according to example embodiments described herein;

FIG. 5A illustrates a detailed view of a portion of a fourth example multi-part preamble according to example embodiments described herein;

FIG. 5B illustrates a detailed view of a portion of a fifth example multi-part preamble according to example embodiments described herein;

FIG. 6A illustrates a flow diagram of first example operations occurring in a transmitting device as the transmitting device transmits a multi-part preamble that includes STBC encoded information on multiple streams according to example embodiments described herein;

FIG. 6B illustrates a flow diagram of first example operations occurring in a receiving device as the receiving device receives a multi-part preamble that includes STBC encoded information on multiple streams according to example embodiments described herein;

FIG. 7A illustrates a flow diagram of second example operations occurring in a transmitting device as the transmitting device transmits a multi-part preamble that includes duplicated streams according to example embodiments described herein;

FIG. 7B illustrates a flow diagram of second example operations occurring in a receiving device as the receiving device receives a multi-part preamble that includes duplicated streams according to example embodiments described herein; and

FIG. 8 is a block diagram of a processing system that may be used for implementing the devices and methods disclosed herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the embodiments and ways to operate the embodiments disclosed herein, and do not limit the scope of the disclosure.

One embodiment relates to space-time block coded communications. For example, a transmission point encodes a training sequence thereby producing an encoded training sequence, places the encoded training sequence in a first part of a multi-part preamble, and transmits the multi-part preamble using a first transmit antenna and a second transmit antenna.

The embodiments will be described with respect to example embodiments in a specific context, namely communications systems that use space-time block codes to improve communications performance. The embodiments may be applied to standards compliant FD communications systems, such as those that are compliant with IEEE 802.11, and the like, technical standards, and non-standards compliant communications systems, that use space-time block codes to improve communications performance.

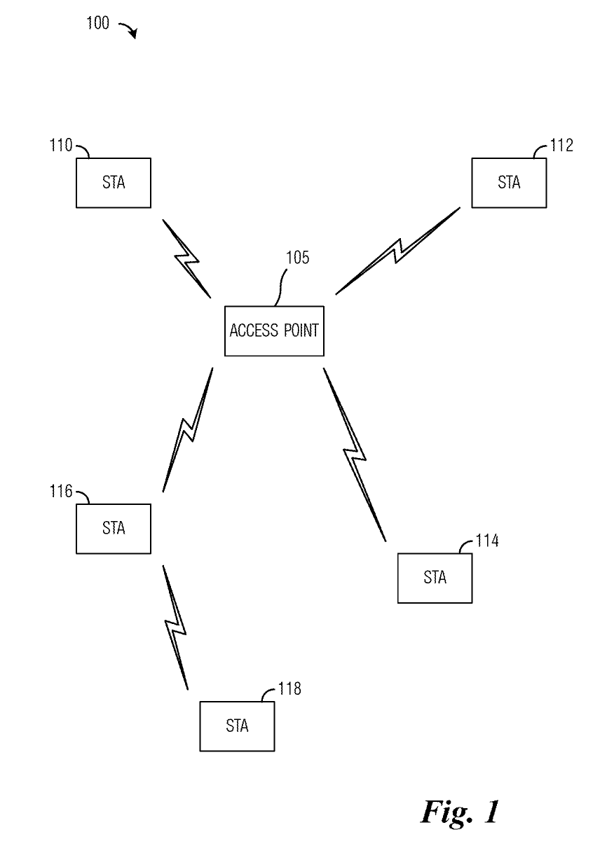

FIG. 1 illustrates an example wireless communications system 100. Wireless communications system 100 includes an access point (AP) 105 that serves one or more stations, such as stations (STA) 110-116, by receiving communications originating from the stations and then forwarding the communications to their intended destinations or receiving communications destined to the stations and then forwarding the communications to their intended stations. In addition to communicating through AP 105, some stations may directly communicate with one another. As an illustrative example, station 116 may transmit directly to station 118. While it is understood that communications systems may employ multiple APs capable of communicating with a number of stations, only one AP, and a number of stations are illustrated for simplicity.

Transmissions to and/or from a station occur on a shared wireless channel. WLANs make use of carrier sense multiple access with collision avoidance (CSMA/CA), where a station desiring to transmit needs to contend for access to the wireless channel before it can transmit. A station may contend for access to the wireless channel using a network allocation vector (NAV). The NAV may be set to a first value to represent that the wireless channel is busy and to a second value to represent that the wireless channel is idle. The NAV may be set by station in accordance with physical carrier sensing and/or reception of transmissions from other stations and/or APs.

In legacy 802.11 compliant communications systems (i.e., a communications system that is compliant to older versions of the 802.11 technical standards), the preamble portion of a packet is transmitted with a modulation and coding scheme (MCS) level 0 without beamforming and only a single data stream is used. However, as discussed above, an outdoor usage scenario has been added to possible applications of 802.11ax, and the legacy preamble portion of a packet (which is needed for backwards compatibility) is vulnerable in the hostile outdoor environment. In general, the legacy preamble portion includes signals and formats that are specified in the older versions of the technical standards (such as the 802.11 technical standards). The presence of the legacy preamble portion in packets compliant with newer versions of the technical standards allows legacy communications devices to detect the presence of such packets, although they may not be able to make use of features specified in the newer versions of the technical standards. Therefore, there is a need for systems and methods that provide compatibility with legacy devices (devices that are compliant with the older versions of the technical standards) while improving communications performance in the outdoor environment.

Space-time block coding (STBC) is a multiple input multiple output (MIMO) technique that transmits multiple copies of a data stream using a plurality of transmit antennas. A receiver of the STBC transmissions may have one or more receive antennas. The receiver receives multiple versions of the data and applies processing to the multiple received versions to improve communications performance. In general, the receiver combines the multiple received versions to obtain as much information as possible from each of the multiple received versions. The repetition of the data stream in STBC transmissions provides diversity gain, thereby improving communications performance.

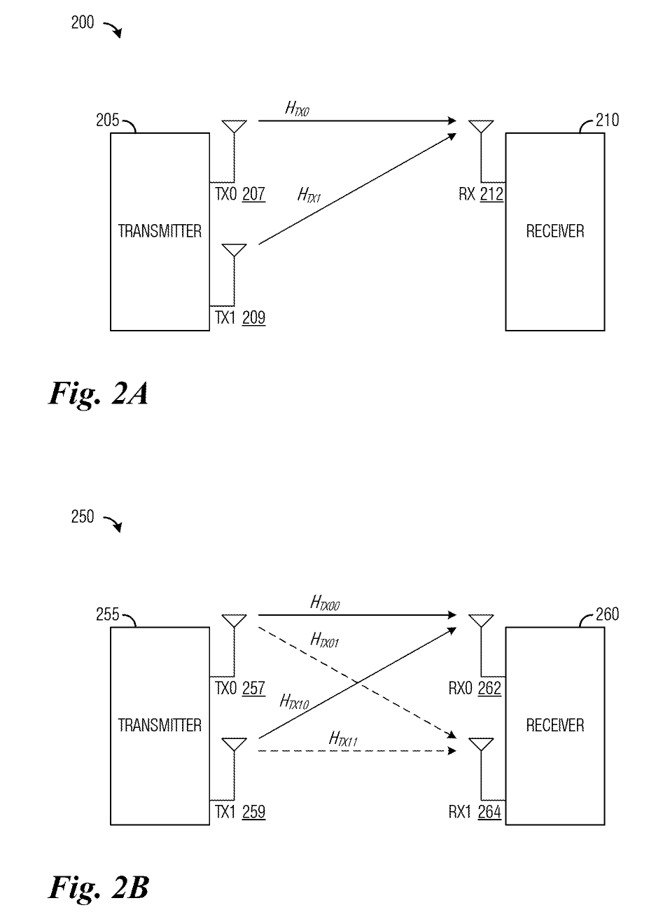

FIG. 2A illustrates a portion of a first communications system 200. First communications system 200 includes a transmitter 205 with two transmitters (TX0 207 and TX1 209) and a receiver 210 with a single receiver (RX 212). Transmissions from transmitter 205 to receiver 210 occur over two communications channels with a first communications channel between TX0 207 and RX 212 and a second communications channel between TX1 209 and RX 212. The two communications channels may be modeled as H_{TX0} and H_{TX1}, respectively.

FIG. 2B illustrates a portion of a second communications system 250. Second communications system 250 includes a transmitter 255 with two transmitters (TX0 257 and TX1 259) and a receiver 260 with two transmitters (RX0 262 and RX1 264). Transmissions from transmitter 205 to receiver 210 occur over four communications channels with a first communications channel between TX0 257 and RX0 262, a second communications channel between TX1 259 and RX0 262, a third communications channel between TX0 257 and RX1 264, and a fourth communications channel between TX1 259 and RX1 264. The four communications channels may be modeled as H_{TX00}, H_{TX10}, H_{TX01}, and H_{TX11}, respectively.

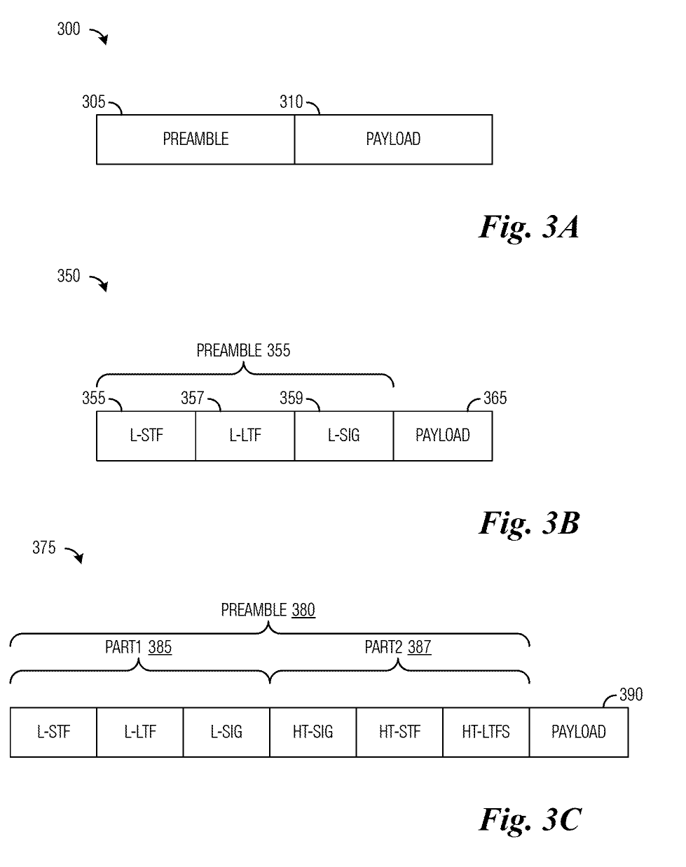

FIG. 3A illustrates an example packet 300. Packet 300 includes a preamble 305 and a payload 310. Preamble 305 includes control information, such as address information, transmission configuration information, decoding information, and so on. Preamble 305 also includes sequences to help a receiver synchronize with the transmitter of packet 300 to enable successful reception and decoding of packet 300. Payload 310 includes data, control information, or a combination thereof.

FIG. 3B illustrates an example packet 350 of an 802.11a compliant communications system. Packet 350 includes a preamble 355 and a payload 365. Preamble 355 includes, amongst other things, a legacy short training field (L-STF) 355, a legacy long training field (L-LTF) 357, and a legacy signal field (L-SIG) 359. L-STF 355 carries the 802.11a short training orthogonal frequency division multiplexed (OFDM) symbol, L-LTF 357 carries the 802.11a long training OFDM symbol, and L-SIG 359 is used to transfer rate and length information. L-SIG 359 may include important information such as physical layer convergence protocol (PLCP) protocol data unit (PPDU) length and cannot be ignored. Payload 365 includes data, control information, or a combination thereof.

FIG. 3C illustrates an example mixed mode 802,11n packet 375. Mixed mode packet 375 includes a preamble 380 and a payload 390. Preamble 380 is a multi-part preamble, with a first part (part1) 385 and a second part (part2) 387. First part 385 provides compatibility with legacy devices, while second part 387 includes new control information to support additional functionality (high throughput (HT) operation in this example). Both first part 385 and second part 387 are transmitted at MCS level 0 without beamforming and only a single data stream is used.

According to an example embodiment, a multi-part preamble with each part including two STBC data streams is provided. The inclusion of two STBC data streams enables diversity gain, thereby improving communications performance, such as in outdoor environments.

According to an example embodiment, a multi-part preamble with a first part including two streams is provided, wherein the two streams are duplicated. The two duplicated streams enable compatibility with legacy devices since the additional stream (beyond the first stream) is seen as multipath by legacy devices.

According to an example embodiment, a multi-part preamble with a second part including two STBC encoded spatial streams is provided, wherein the two STBC encoded spatial streams each include a new long training field (SIG-LTF). The two STBC data streams enable diversity gain, thereby improving communications performance.

Although the discussion focuses on two STBC encoded spatial streams, the example embodiments presented herein are operable with more than two STBC encoded spatial streams. Therefore, the discussion of two STBC encoded spatial streams should not be construed as being limiting to either the scope or the spirit of the example embodiments.

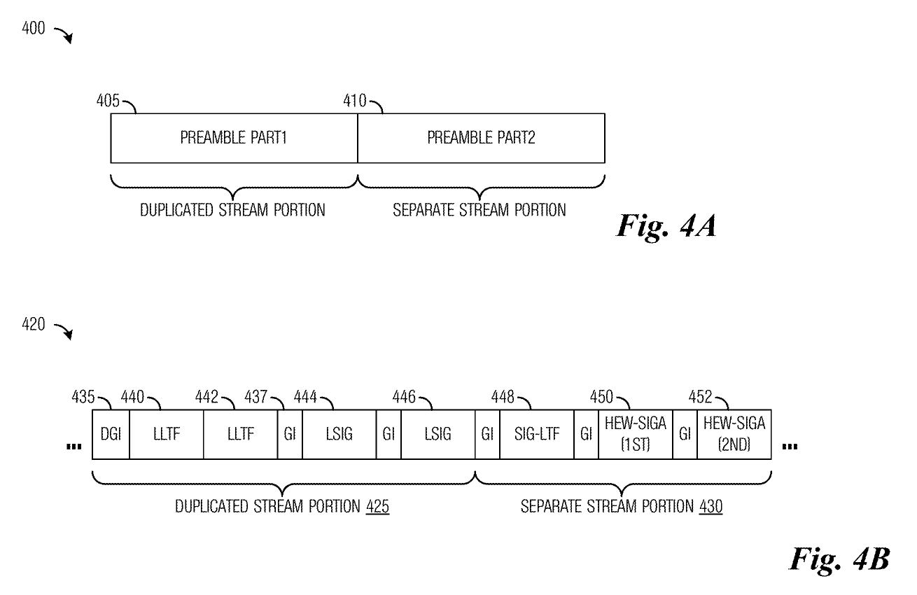

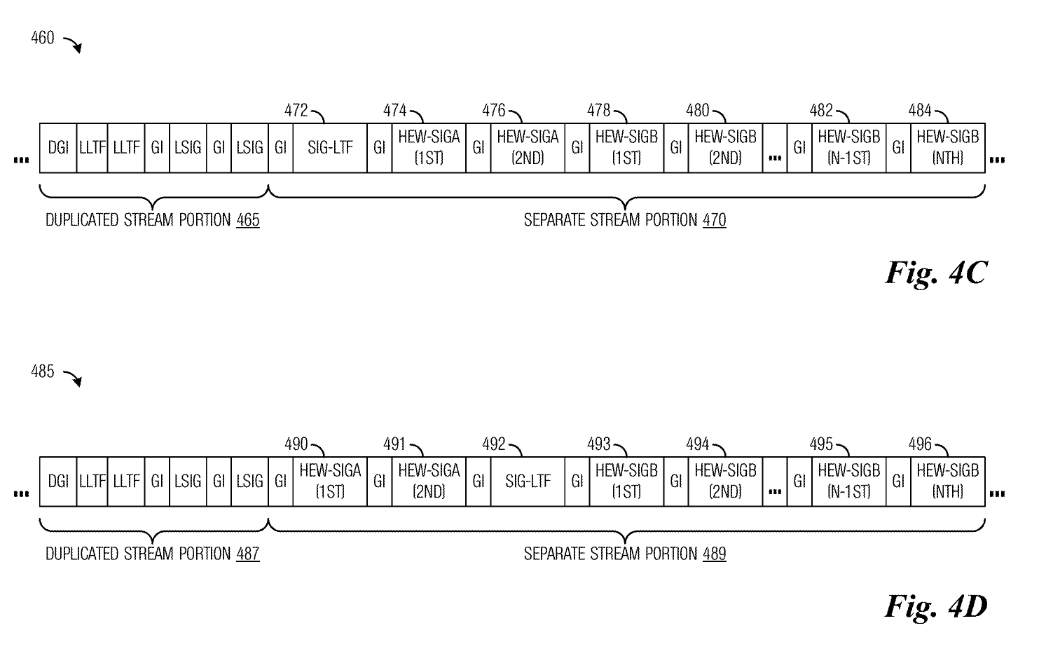

FIG. 4A illustrates a high-level view of a multi-part preamble 400 wherein each part includes two STBC data streams. Multi-part preamble 400 includes a first part (preamble part1) 405 and a second part (preamble part2) 410. First part 405 includes two STBC data streams that contain duplicated information and second part 410 includes two STBC data streams that contain differently encoded data streams. First part 405 may be referred to as a duplicated stream portion and second part 410 may be referred to as separate stream portion. Second part 410 includes a new long training field.

FIG. 4B illustrates a detailed view of a portion of a first example multi-part preamble 420. Multi-part preamble may be as shown in FIG. 4A. Multi-part preamble 420 includes a duplicated stream portion 425 and a separate stream portion 430. Duplicated stream portion 425 includes, amongst other things, a double guard interval (DGI) 435, several guard intervals (GI) such as GI 437, consecutive legacy LTF (LLTF) fields, LLTF 440 and LLTF 442, and repeated legacy SIG (LSIG) fields separated by a GI, LSIG 444 and LSIG 446. Duplicated stream portion 425 may also include legacy STF fields that are not shown in FIG. 4B. A single data stream is duplicated two times in duplicated stream portion 425. In other words, each antenna of a transmitting device may transmit duplicated stream portion 425. Cyclic delay diversity (CDD) may be applied to the different duplicated streams in the frequency domain. Since the information is duplicated over multiple streams, legacy devices do not see much difference from when the information is transmitted on a single stream with each of the multiple streams appearing to the legacy as multipath reflections of one another.

A technique to help in the proper decoding of the LSIG field is to repeat the LSIG field (i.e., LSIG 444 and LSIG 446). The repetition of the LSIG field increases the effective transmission power of the information in the LSIG field as well as provides for diversity gain. Furthermore, since the LSIG field has not been repeated in legacy preambles, the repeated LSIG field may be used for early auto-detection of 802.11ax compliant devices. In other words, if an 802.11ax compliant device determines that the preamble of the packet that it is receiving has a repeated LSIG field, then it knows even before completely decoding the preamble that the packet is an 802.11ax compliant packet. As an illustrative example, an 802.11ax compliant device may perform cross correlation of symbols corresponding to the back-to-back GI+LSIG fields and if the magnitude of the cross correlation exceeds a threshold, the 802.11ax compliant device may determine that the packet is an 802.11ax packet.

Separate stream portion 430 includes a SIG-LTF field 448, and two HEW-SIGA fields, a first HEW-SIGA field 450 and a second HEW-SIGA field 452, carrying a first and a second symbol of the HEW-SIGA, separated by GIs. In order to support the decoding of the HEW-SIGA fields, which are STBC encoded and transmitted over two spatial streams, two training sequences are required: the LLTF fields in duplicated stream portion 425 and SIG-LTF field 448 in separate stream portion 430 provide the training sequences needed for decoding of the two spatial streams. The LLTF fields and SIG-LTF field 448 provide the LTF needed for 2×2 MIMO channel decoding.

Design of the LTF (the LLTF fields and the SIG-LTF field) may follow the design of current 802.11 LTFs. A long training sequence (LTS) is mapped from two space-time streams to two LTFs (the LLTF and the SIG-LTF as shown in FIG. 4B) as specified in the 802.11ac technical standards, using a P-matrix. A mathematical representation of the LTF design is as follows:

[LLTFₖ,SIG-LTFₖ]_{N}_{_{TX}}_{×2}=QₖD_{CDD}^{(k)}P_{2×2}sₖ,

where

$${P}_{2 \times 2} = [ \begin{matrix}1 & - 1 \\ 1 & 1\end{matrix} ] ,$$

sₖ is the LTS in tone k, Qₖ is a spatial mapping matrix between 2 streams and N_{TX} with omni-directional beams, D_{CDD}^{(k)} is a diagonal CDD phase shift matrix of size 2×2 for tone k, and N_{TX} is the number of transmit antennas.

The STBC encoding of HEW-SIGA for fields 450 and 452 may follow the STBC encoding rules as specified in the 802.11 technical standards. Table 1 presents the STBC encoding for 1 spatial stream (N_{SS}=1) and 2 space-time streams (N_{STS}=2), where i_{STS} is the index of a space-time stream, s_{k,1,2t} is the HEW-SIGA first symbol at the k-th tone, and s_{k,1,2t+1} is the HEW-SIGA second symbol at the k-th tone, k is the tone index, i is the spatial stream index, t is a time or symbol index, s*_{k,1,2t} is a complex conjugate of s_{k,1,2t}, and −s*_{k,1,2t+1} is a negative complex conjugate of s_{k,1,2t+1}.

TABLE 1
Encoding with STBC with N_{SS} = 1 and N_{STS} = 2.

| N_{STS} | N_{SS} | i_{STS} | \tilde{s}_{k, i, 2t} | \tilde{s}_{k, i, 2t+1} |
|---|---|---|---|---|
| 2 | 1 | 1 | s_{k, 1, 2t} | s_{k, 1, 2t+1} |
| | | 2 | −s_{k, 1, 2t+1}* | s_{k, 1, 2t}* |

FIG. 4C illustrates a detailed view of a portion of a second example multi-part preamble 460. Multi-part preamble 460 includes a duplicated stream portion 465 and a separate stream portion 470. Duplicated stream portion 465 may be as described in FIG. 4B. Like separate stream portion 430 shown in FIG. 4B, separate stream portion 470 includes a SIG-LTF field 472 and two HEW-SIGA fields (a first HEW-SIGA field 474 and a second HEW-SIGA field 476). However, separate stream portion 470 also includes HEW-SIGB fields, such as first and second HEW-SIGB fields 478 and 480, as well as N−1st and Nth HEW-SIGB fields 482 and 484. In general, there may any arbitrary even number of HEW-SIGB fields. Individual fields in separate stream portion 470 are separated by GIs. Since SIG-LTF field 472 appears before the HEW-SIGA fields and the HEW-SIGB fields, both the HEW-SIGA fields and the HEW-SIGB fields may be STBC encoded, although they are not both required to be STBC encoded. The encoding of the symbols in the HEW-SIGB fields may follow the description of the encoding of the symbols of the HEW-SIGA fields presented above.

FIG. 4D illustrates a detailed view of a portion of a third example multi-part preamble 485. Multi-part preamble 485 includes a duplicated stream portion 487 and a separate stream portion 489. Duplicated stream portion 487 may be as described in FIG. 4B. Separate stream portion 489 includes two HEW-SIGA fields (a first HEW-SIGA field 490 and a second HEW-SIGA field 491) and a SIG-LTF field 492. Separate stream portion 489 also includes HEW-SIGB fields, such as first and second HEW-SIGB fields 493 and 494, as well as N−1st and Nth HEW-SIGB fields 495 and 496. In general, there may any arbitrary even number of HEW-SIGB fields. Individual fields in separate stream portion 489 are separated by GIs. Since the HEW-SIGA fields come before SIG-LTF field 492, the HEW-SIGA fields are not STBC encoded. The HEW-SIGA fields may be duplicated in the multiple streams in a manner similar to duplicated stream portion 487. However, the HEW-SIGB fields may be STBC encoded. The encoding of the symbols in the HEW-SIGB fields may follow the description of the encoding of the symbols of the HEW-SIGA fields presented above.

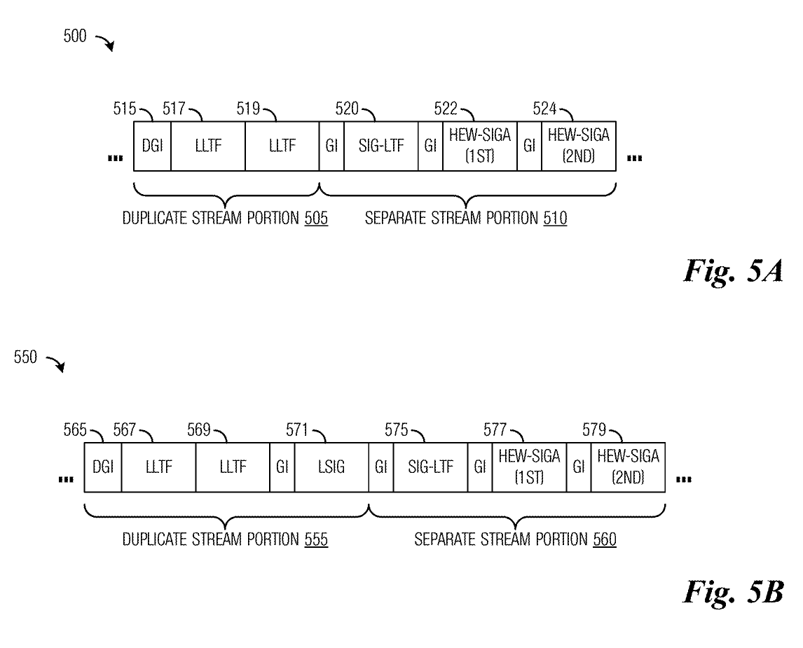

FIG. 5A illustrates a detailed view of a portion of a fourth example multi-part preamble 500. Multi-part preamble 500 includes a duplicate stream portion 505 and a separate stream portion 510. Duplicate stream portion 505 includes a DGI 515 and repeated LLTF fields 517 and 519. Duplicated stream portion 505 may also include legacy STF fields that are not shown in FIG. 5A. Duplicate stream portion 505 differs from duplicate stream portion 455 of FIG. 4B in that the LSIG fields are omitted. Separate stream portion 510 includes a SIG-LTF field 520, and two HEW-SIGA fields, a first HEW-SIGA field 522 and a second HEW-SIGA field 524, carrying a first and a second symbol of the HEW-SIGA. Multi-part preamble 500 offers reduced communications overhead due to its smaller size. The same LTF design used to estimate the 2 streams channel as was described with respect to FIG. 1 is used for this design, and the same STBC encoding as described is applied to the HEW-SIGA (1^{st}) and (2^{nd}) symbols. In the case of Legacy packet transmission such as in 802.11a, 802.11n, or 802.11ac, the SIG-LTF 520 may be replaced by L-SIG, and the HEW-SIGA symbols (522 and 524) may be replaced by data symbols or (V)HT-SIG symbols depending on which legacy packet is transmitted.

The auto-detection for the HEW packet transmission using the preamble design in FIG. 5A can be achieved using the HEW-SIGA. Since the HEW-SIGA is modulated in QPSK, the energy detection between the real part and the imaginary part of HEW-SIGA may have a similar trend. The difference between the energy detection of the real part and the energy of the imaginary part will be smaller than the difference of HT-SIGA (802.11n SIG field) or VHT-SIGA (802.11ac SIG field). Thus, we may provide the auto-detection capability from 802.11n or 802.11ac using HEW-SIGA. If the 802.11a packet whose three consecutive symbols immediately following the L-SIG field are modulated in BPSK, QPSK, and QPSK, then the false alarm for the HEW devices might occur when the 802.11a packet is actually transmitted. In this case, the CRC check of the HEW-SIGA symbols may be used to determine the false alarm.

FIG. 5B illustrates a detailed view of a portion of a fifth example multi-part preamble 550. Multi-part preamble 550 includes a duplicate stream portion 555 and a separate stream portion 560. Duplicate stream portion 555 includes a DGI 565, repeated LLTF fields 567 and 569, and a LSIG field 571. Duplicated stream portion 505 may also include legacy STF fields that are not shown in FIG. 5B. Duplicate stream portion 555 differs from duplicate stream portion 455 of FIG. 4B in that only one LSIG field is present. Separate stream portion 560 includes a SIG-LTF field 575, and two HEW-SIGA fields, a first HEW-SIGA field 577 and a second HEW-SIGA field 579, carrying a first and a second symbol of the HEW-SIGA. Multi-part preamble 550 offers reduced communications overhead due to its smaller size while retaining the LSIG field. The same LTF design to estimate the two streams channel as was described with respect to FIG. 4B is used for this design, and the same STBC encoding is applied to the HEW-SIGA (1st) and (2nd) symbols.

The auto-detection for the HEW packet transmission using the preamble design as shown in FIG. 5B can be achieved using the HEW-SIGA shown in FIG. 5A. Since the HEW-SIGA is modulated in QPSK, the energy detection between the real part and the imaginary part of HEW-SIGA might have the similar trend. The difference between the energy detection of real part and the energy of imaginary part will be smaller than the difference of HT-SIGA (802.11n SIG field) or VHT-SIGA (802.11ac SIG field). Thus, it is possible to provide the auto-detection capability from 802.11n or 802.11ac using HEW-SIGA. If the 802.11a packet whose three consecutive symbols immediately following the L-SIG field are modulated in BPSK, QPSK, and QPSK, then the false alarm for the HEW devices might occur when the 802.11a packet is actually transmitted. In this case, the CRC check of the HEW-SIGA symbols may be used to determine the false alarm. It is noted that variants of the multi-part preambles shown in FIGS. 5A and 5B that include even numbers of HEW-SIGB fields are possible. The variants would look similar to the multi-part preambles shown in FIGS. 4C and 4D.

With respect to band indication with mixed client services, when the receiver bandwidth of each station is different, especially when different from the transmitter bandwidth of the access point, each station may need to be informed of the band indication for each station to tune in. One half the tones of inverse fast Fourier transform (IFFT) input in the transmitter side are swapped with the other half the tones of the input before the IFFT is taken at the transmitter side, which causes each station difficulty in tuning to the right band when the bandwidth of station is smaller than the access point transmission bandwidth. Therefore, the access point informs each station of its corresponding band to tune in beforehand, in case the receiver bandwidth of each station is a sub-set of the entire bandwidth of the transmission bandwidth in the transmitter side.

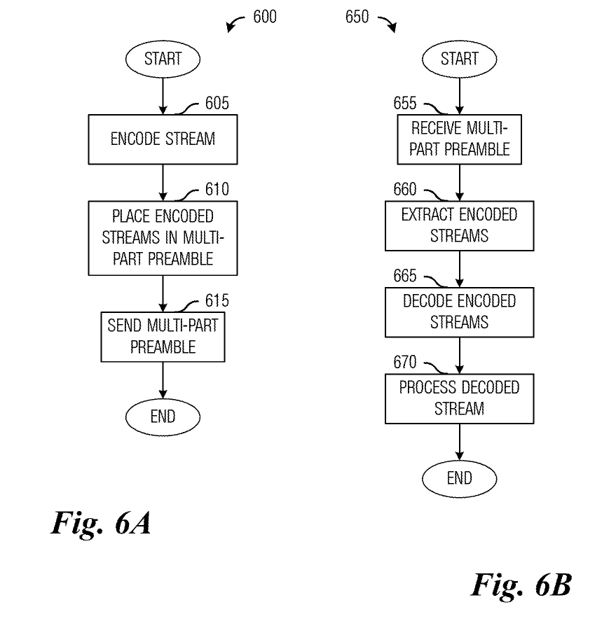

FIG. 6A illustrates a flow diagram of first example operations 600 occurring in a transmitting device as the transmitting device transmits a multi-part preamble that includes STBC encoded information on multiple streams. Operations 600 may be indicative of operations occurring in a transmitting device as the transmitting device encodes space-time streams of a multi-part preamble using STBC and transmits the multi-part preamble.

Operations 600 begin with the transmitting device encoding two space-time streams using STBC (block 605). As an illustrative example, the encoding of the two space-time streams is as presented in Table 1. The two space-time streams may correspond to a HEW-SIGA sequence, a HEW-SIGB sequence, and/or a LLTF and SIG-LTF sequence. The transmitting device places the encoded streams in a multi-part preamble (block 610). The transmitting device sends the multi-part preamble (block 615).

FIG. 6B illustrates a flow diagram of first example operations 650 occurring in a receiving device as the receiving device receives a multi-part preamble that includes STBC encoded information on multiple streams. Operations 650 may be indicative of operations occurring in a receiving device as the receiving device decodes encoded streams contained in the multi-part preamble.

Operations 650 begin with the receiving device receiving the multi-part preamble (block 655). The receiving device extracts STBC encoded streams from the multi-part preamble (block 660). The receiving device decodes the STBC encoded streams (block 665). The decoding of the STBC encoded streams is dependent on the number of receive antennas at the receiving device. As an illustrative example, Table 2 presents the symbols of the HEW-SIGA and/or HEW-SIGB as transmitted by a transmitting device transmitting 2 space-time streams, where TX0 and TX1 are the 2 space-time streams, t₀ and t₁ are consecutive symbol times, and s₀ and s₁ are the first and second symbols of the HEW-SIGA and/or HEW-SIGB. Symbols of other STBC encoded sequences may have similar appearance and their decoding may follow in a similar manner.

TABLE 2
Symbols of HEW-SIGA as transmitted on 2 space-time streams.

| | t₀ | t₁ |
|---|---|---|
| TX0 | s₀ | s₁ |
| TX1 | −s₁* | s₀* |

In a situation where the receiving device has a single receive antenna (as shown in FIG. 2A, for example), the received signal at symbol time t₀ is yₜ_{₀} and symbol time t₁ is yₜ_{₁}, which are expressible as

yₜ_{₀}=s₀H_{TX0}−s*₁H_{TX1}

and

yₜ_{₁}=s₁H_{TX0}+s*₀H_{TX1}.

The received signals (\tilde{s}₀ and \tilde{s}₁), also known as STBC detections of signals s₀ and s₁, may then be expressed as

\tilde{s}₀=H*_{TX0}yₜ_{₀}+H_{TX1}y*ₜ_{₁}

and

\tilde{s}₁=−H_{TX1}y*ₜ_{₀}+H*_{TX1}yₜ_{₁}.

In a situation where the receiving device has 2 receive antennas (as shown in FIG. 2B, for example), the received signal at symbol time t₀ with RX0 is yₜ_{₀}_{RX}0, at symbol time t₀ with RX1 is yₜ_{₀}_{RX}1, at symbol time t₁ with RX0 is yₜ_{₁}_{RX}0, and at symbol time t₁ with RX1 is yₜ_{₁}_{RX}1, which are expressible as

yₜ_{₀}_{RX}0=s₀H_{TX00}−s*₁H_{TX01}

yₜ_{₀}_{RX}1=s₀H_{TX10}−s*₁H_{TX11}

yₜ_{₁}_{RX}0=s₁H_{TX00}+s*₀H_{TX01}

and

yₜ_{₁}_{RX}1=s₁H_{TX10}+s*₀H_{TX11}

The received signals (\tilde{s}₀ and \tilde{s}₀), also known as STBC detections of signals s₀ and s₁, may then be expressed as

\tilde{s}₀=H*_{TX00}yₜ_{₀}_{RX}0+H_{TX01}y*ₜ_{₁}_{RX}0+H*_{TX10}yₜ_{₀}_{RX}1+H_{TX11}y*ₜ_{₁}_{RX}1

and

\tilde{s}₁=H*_{TX10}yₜ_{₁}_{RX}1−H_{TX11}y*ₜ_{₀}_{RX}1+H*_{TX00}yₜ_{₁}_{RX}0+H_{TX01}y*ₜ_{₀}_{RX}0.

The receiving device processes the decoded space-time streams (block 670).

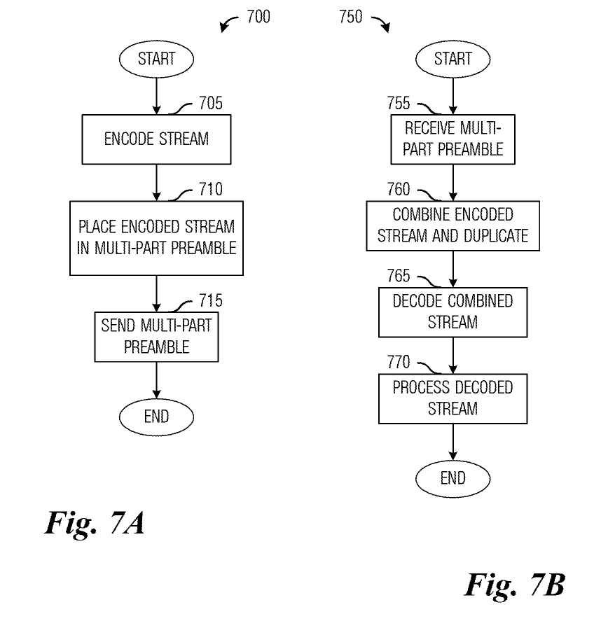

FIG. 7A illustrates a flow diagram of second example operations 700 occurring in a transmitting device as the transmitting device transmits a multi-part preamble that includes duplicated streams. Operations 700 may be indicative of operations 700 occurring in a transmitting device as the transmitting device encodes a stream of a multi-part preamble and duplicates the encoded stream for transmission of the multi-part preamble.

Operations 700 begin with the transmitting device encoding a stream (block 705). The transmitting device may encode the stream using any selected encoding method and code. The transmitting device places the encoded stream into a multi-part preamble (block 710). The transmitting device sends the multi-part preamble (block 715).

FIG. 7B illustrates a flow diagram of second example operations 750 occurring in a receiving device as the receiving device receives a multi-part preamble that includes duplicated streams. Operations 750 may be indicative of operations occurring in a receiving device as the receiving device decodes an encoded stream and its duplicate contained in a multipart preamble.

Operations 750 begin with the receiving device receiving the multi-part preamble (block 755). The receiving device combines the encoded stream and its duplicate (block 760). As an illustrative example, the receiving device simply adds the encoded stream and its duplicate. Alternatively, the receiving device applies a weight to one or both of the encoded stream and its duplicate and then adds them together. The receiving device decodes the combined stream (block 765). The receiving device processes the decoded stream (block 770).

An example embodiment provides STBC-based SIG field design. An example embodiment provides a design using the duplicated streams concept. An example embodiment provides MCS 1 modulation for the SIG field. An example embodiment provides auto-detection for the HEW packet. An example embodiment provides reliable SIG field transmission in the outdoor channel. An example embodiment provides backward compatibility with legacy devices. An example embodiment provides auto-detection of the HEW packet. Example embodiments may be implemented in WLAN systems and devices, such as access points, stations, chips, and the like.

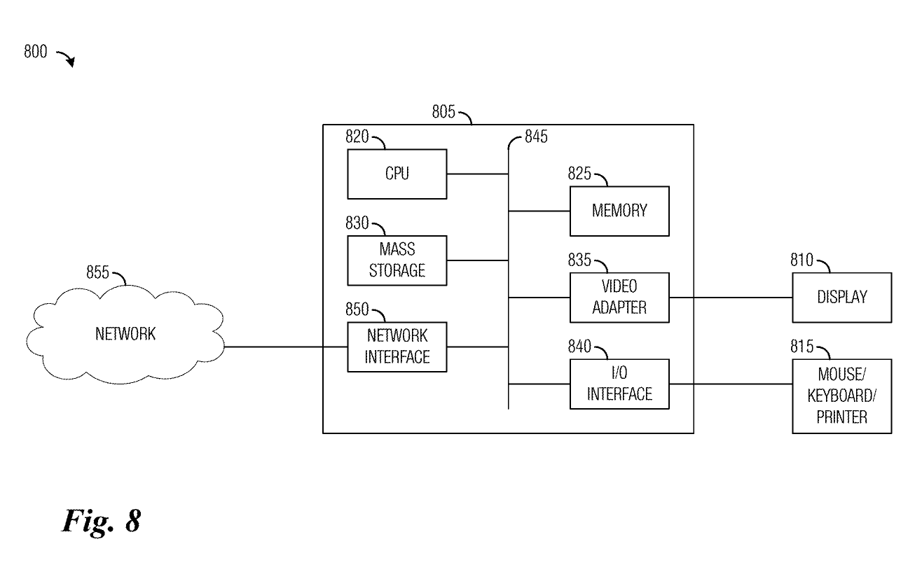

FIG. 8 is a block diagram of a processing system 800 that may be used for implementing the devices and methods disclosed herein. In some embodiments, the processing system 800 comprises a UE. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit 805 equipped with one or more input/output devices, such as a human interface 815 (including speaker, microphone, mouse, touchscreen, keypad, keyboard, printer, and the like), display 810, and so on. The processing unit may include a central processing unit (CPU) 820, memory 825, a mass storage device 830, a video adapter 835, and an I/O interface 840 connected to a bus 845.

The bus 845 may be one or more of any type of several bus architectures including a memory bus or memory controller, a peripheral bus, video bus, or the like. The CPU 820 may comprise any type of electronic data processor. The memory 825 may comprise any type of system memory such as static random access memory (SRAM), dynamic random access memory (DRAM), synchronous DRAM (SDRAM), read-only memory (ROM), a combination thereof, or the like. In an embodiment, the memory 825 may include ROM for use at boot-up, and DRAM for program and data storage for use while executing programs.

The mass storage device 830 may comprise any type of storage device configured to store data, programs, and other information and to make the data, programs, and other information accessible via the bus 845. The mass storage device 830 may comprise, for example, one or more of a solid state drive, hard disk drive, a magnetic disk drive, an optical disk drive, or the like.

The video adapter 835 and the I/O interface 840 provide interfaces to couple external input and output devices to the processing unit 800. As illustrated, examples of input and output devices include the display 810 coupled to the video adapter 835 and the mouse/keyboard/printer 815 coupled to the I/O interface 840. Other devices may be coupled to the processing unit 800, and additional or fewer interface devices may be utilized. For example, a serial interface such as Universal Serial Bus (USB) (not shown) may be used to provide an interface for a printer.

The processing unit 800 also includes one or more network interfaces 850, which may comprise wired links, such as an Ethernet cable or the like, and/or wireless links to access nodes or different networks 855. The network interface 850 allows the processing unit 800 to communicate with remote units via the networks 855. For example, the network interface 850 may provide wireless communication via one or more transmitters/transmit antennas and one or more receivers/receive antennas. In an embodiment, the processing unit 800 is coupled to a local-area network or a wide-area network 855 for data processing and communications with remote devices, such as other processing units, the Internet, remote storage facilities, or the like.

Although the present disclosure and its advantages have been described in detail, it should be understood that various changes, substitutions and alterations can be made herein without departing from the spirit and scope of the disclosure as defined by the appended claims.

What is claimed is:

1. A method for wireless communications, the method comprising:
encoding, by a transmission point, a training sequence thereby producing an encoded training sequence;
placing, by the transmission point, the encoded training sequence in a first part of a multi-part preamble; and
transmitting, by the transmission point, the multi-part preamble on at least two streams using a first transmit antenna and a second transmit antenna.

2. The method of claim 1, wherein the training sequence comprises a legacy long training sequence.

3. The method of claim 1, further comprising placing an encoded legacy signal sequence in the first part of the multi-part preamble.

4. The method of claim 3, wherein the encoded legacy signal sequence comprises an encoded legacy signal sequence.

5. The method of claim 3, further comprising placing a duplicate of the encoded signal sequence in the first part of the multi-part preamble.

6. The method of claim 5, further comprising placing a guard interval between the encoded signal sequence and the duplicate of the encoded signal sequence in the first part of the multi-part preamble.

7. The method of claim 1, wherein the multi-part preamble further comprises a second part including two space-time streams.

8. A method for wireless communications, the method comprising:
space-time block code (STBC) encoding, by a transmission point, a signal thereby producing two space-time streams;
placing, by the transmission point, the two space-time streams in a first part of a multi-part preamble; and
transmitting, by the transmission point, the multi-part preamble.

9. The method of claim 8, wherein the signal further comprises at least one of a high efficiency wireless local area network (WLAN) (HEW) signal A (SIGA) signal in a HEW-SIGA field and a HEW signal B (SIGB) signal in a HEW-SIGB field.

10. The method of claim 9, wherein the signal comprises a training sequence in a signal long training field (SIG-LTF).

11. The method of claim 8, wherein STBC encoding the signal produces 2 space-time streams, wherein the 2 space-time streams are expressible as

| i_{STS} | \tilde{s}_{k, i, 2t} | \tilde{s}_{k, i, 2t+1} |
|---|---|---|
| 1 | s_{k, 1, 2t} | s_{k, 1, 2t+1} |
| 2 | −s_{k, 1, 2t+1}* | s_{k, 1, 2t}* |

where i_{STS} is an index of a space-time stream, s_{k,1,2t} is a first symbol of the signal at a k-th tone, and s_{k,1,2t+1} is a second symbol of the signal at a k-th tone, k is a tone index, i is a spatial stream index, t is a time or symbol index, s*_{k,1,2t} is a complex conjugate of s_{k,1,2t}, and −s*_{k,1,2t+1} is a negative complex conjugate of s_{k,1,2t+1}.

12. The method of claim 8, wherein the multi-part preamble further comprises a first part including duplicated space-time streams.

13. A transmission point comprising:
a processor; and
a computer readable storage medium storing programming for execution by the processor, the programming including instructions configuring the transmission point to:
encode a training sequence thereby producing an encoded training sequence,
place the encoded training sequence in a first part of a multi-part preamble, and
transmit the multi-part preamble on at least two streams using a first transmit antenna and a second transmit antenna.

14. The transmission point of claim 13, wherein the training sequence comprises a legacy long training sequence.

15. The transmission point of claim 13, wherein the programming includes instructions to place an encoded legacy signal sequence in the first part of the multi-part preamble.

16. The transmission point of claim 15, wherein the encoded legacy signal sequence comprises an encoded legacy signal sequence.

17. The transmission point of claim 15, wherein the programming includes instructions to place a duplicate of the encoded signal sequence in the first part of the multi-part preamble.

18. The transmission point of claim 17, wherein the programming includes instructions to place a guard interval between the encoded signal sequence and the duplicate of the encoded signal sequence in the first part of the multi-part preamble.

19. A transmission point comprising:
a processor; and
a computer readable storage medium storing programming for execution by the processor, the programming including instructions configuring the transmission point to:
space-time block code (STBC) encode a signal thereby producing two space-time streams,
place the two space-time streams in a first part of a multi-part preamble, and
transmit the multi-part preamble.

20. The transmission point of claim 19, wherein the signal comprises a training sequence in a signal long training field (SIG-LTF).

21. The transmission point of claim 20, wherein the signal further comprises at least one of a high efficiency wireless local area network (WLAN) (HEW) signal A (SIGA) signal in a HEW-SIGA field and a HEW signal B (SIGB) signal in a HEW-SIGB field.

22. The transmission point of claim 19, wherein the programming includes instructions to produce 2 space-time streams expressible as

| i_{STS} | \tilde{s}_{k, i, 2t} | \tilde{s}_{k, i, 2t+1} |
|---|---|---|
| 1 | s_{k, 1, 2t} | s_{k, 1, 2t+1} |
| 2 | −s_{k, 1, 2t+1}* | s_{k, 1, 2t}* |

where i_{STS} is an index of a space-time stream, s_{k,1,2t} is a first symbol of the signal at a k-th tone, and S_{k,1,2t+1} is a second symbol of the signal at a k-th tone, k is a tone index, i is a spatial stream index, t is a time or symbol index, s*_{k,1,2t} is a complex conjugate of s_{k,1,2t}, and −s*_{k,1,2t+1} is a negative complex conjugate of s_{k,1,2t+1}.
